(19) United States
(12) Patent Application Publication
(10) Pub. No.: US 2004/0213397 A1
(43) Pub. Date: Oct. 28, 2004

(54) Call processing circuit for non-user defined abbreviated phone numbers and non-phone-number Caller ID

(76) Inventor: Nader Zarabi, Calgary (CA)

Correspondence Address: NADER ZARABI, # 1502,620, 67 Ave, S.W., CALGARY, AB, T2V 0M2, CA

(21) Appl. No.: 10/103,269

(22) Filed: Mar. 22, 2002

(51) Int. Cl. H04M 3/42

(52) U.S. Cl. 379/216.01

(57) ABSTRACT

My invention is a call processing circuit built inside a phone or connected to the phone through its I/O interface for uniquely defining/forwarding abbreviated phone numbers over one or several phone-area codes in conjunction with a telephone-computer integration system at an agent station whose phone number is pre-set in the call processing circuit and is automatically dialled if the dialled digits starts with a special ring digit (e.g.; #, *, #*, or *#). The call processing circuit also has unique hardware ID code to be retrieved automatically by called party (without any caller's effort nor any telephony centre involvement) for being used as an alternative non-phone number based Caller ID.

### BACKGROUND OF THE INVENTION

The present invention is for the application of non-caller defined abbreviated phone numbers (e.g.; 1, 2, 3, or 4 digits phone numbers), and for introducing direct phone to phone caller ID as an alternative to the current telephony based Caller ID.

Businesses have been trying to use phone numbers that are easily memorable especially for fast TV, Radio, and outdoor advertising. However, people still can not remember the advertised phone numbers after a short time due to the long digits (7 to 11 digits). As the population grows and phone numbers become bigger, the problem gets worse.

Current caller ID which is based on the caller's phone number has some limitations; 1—It does not always work on phone calls outside one telecomm company, 2—for privacy or other matters, most often the caller's phone number is blocked, 3—It can not prevent phone ring from the annoying calls, 4—any condition based on caller ID restricts the caller to one specific phone and applies equally to all users of that phone line 5—there is a cost associated with this service.

The call processing circuit is addressing all of the above concerns without any change in the existing telecommunication systems and without any effort from users. Therefore, the said V-Chip can be used inside any and among all telecommunication systems.

### SUMMARY OF THE INVENTION

My invention is a call processing circuit (hereinafter, V-Chip) comprising hardware ID code, a buffer memory (temporary memory), a user defined lookup table, and a display unit. It is installed inside or connected to a key phone system thorough its I/O interface for automatic dialling a pre-set agent's phone number when the dialled digits (hereinafter V-number) starts with a special ring signal (e.g., *, #). The agent phone number is the phone number of the phone-computer integration system (hereinafter V-switchboard) where the V-number is referenced and forwarded to its corresponding real phone number. V-numbers are easier to remember and to dial and so are more convenient for many applications; especially for especial public services, big businesses with high traffic phone lines and fast advertising environments (e.g.; TV, radio, outdoor).

Each V-chip has hardware ID code, which can be retrieved by the called party's V-chip through sending special frequency signal to the caller's V-Chip. V-chip allows user to generate a lookup table of hardware IDs and associated names which then can be used as direct phone-to-phone Caller ID instead of the current telephony based caller ID. V-chip's Caller ID is more private, prevent phone ringing/connection on annoying calls, can be used at any time and many times during a call even if the call is forwarded without involvement of any telephony centre and so is free of charge.

Application of V-Chip does not bring any change to the telecom systems and so it can be used world-wide with every telecom system. This is due to the fact that, segregating real and virtual phone numbers are done by V-chip, call forwarding to real numbers is handled by V-switchboard and Caller ID is checked by the called party's V-Chip.

### DESCRIPTION OF THE FIGURES

FIG. 1 shows the installation of both internal and external V-chips and their relation with the rest of the telecommunication systems including V-switchboard. In this figure note that V-chip hardware ID is a removable chip (shown as smart card in FIG. 1) for line security as described below.

FIG. 2 shows the flow chart of the V-chip operation including the logic decisions applied inside the V-chip and flow of data between V-Chip, V-switchboard and telecom system.

### DETAILED DESCRIPTION OF THE INVENTION

The invention consists of the said V-chip with hardware ID code, two memories, a display unit, the procedure for defining non-caller abbreviated phone numbers, and the method for introducing direct phone-to-phone caller ID. All of these will be applied based on no effort from callers and no change in the existing telecom systems.

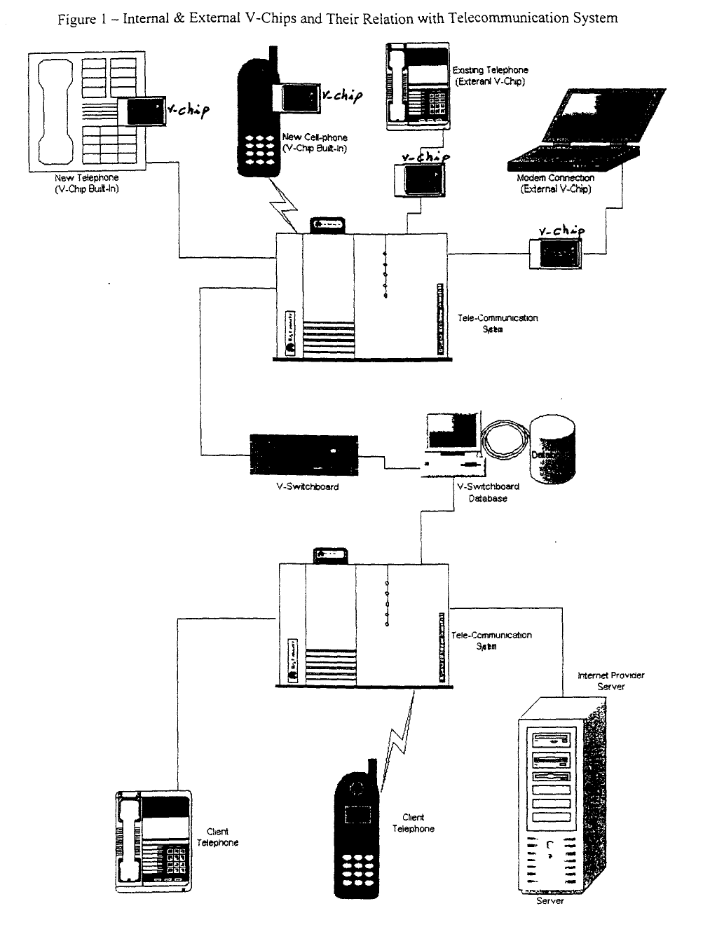

V-Chip is a call processing circuit installed inside the new phones or connected to the existing phones thorough its I/O interfaces as shown in FIG. 1. The said V-Chip comprising; (1) On/Off switch, (2) a memory for storing a pre-set phone number of the agent station, (3) a buffer memory for temporary storage of V-number, (4) hardware ID code, (5) a memory for storing a user defined look-up table, (6) a display unit, and (7) an electronic circuit to support V-chip operations.

The On/Off switch installed on the phone or on the external V-Chip activates or deactivates the V-chip functions manually. When the switch is in “Off” position, the V-Chip is totally ignored and bypassed. When the switch is in “On” position, the V-chip will function without interfering with normal phone operation as explained below. Therefore, the default switch position is assumed to be “On”.

The agent number is the real phone number of an agent station (phone-computer integrated system) that handles call forwarding from the said abbreviated phone numbers to their corresponding real phone numbers. The agent phone number is preloaded into the V-chip and is distributed with it. If the abbreviated phone numbers are segregated area wise, then all the V-chips in one area code shall have the same agent number and the V-chip considered for an area code, may not be used in other area codes.

Buffer memory is for storing V-number (i.e; the abbreviated dialled digits excluding the prefix special ring signal) as the telecom systems do not have buffer capacities. Upon auto-dialling the agent station, the special frequency signal is sent by V-switchboard to caller's V-chip for retrieving its temporary stored V-number and forwarding the call to the final called party according to the computerised directory information connected to the V-switchboard.

The said hardware ID code is a fixed and unique ID number set inside any V-Chip and is used as the identity of the caller. The memory chip storing Hardware ID code is removable and can be transferred from one V-Chip to another. V-Chip has also a memory for storing a look-up table set by the user and a display unit for showing the hardware ID codes and their associated names assigned by the user.

A typical embodiment occurs when a called party's V-chip is set to check the ID of the caller for which it sends the specific frequency signal to the caller's V-chip. Upon receiving that frequency signal, caller's V-chip sends back the hardware ID code to the called party's V-chip where it can be checked against the look-up table and be displayed as hardware ID code and its assigned name. If hardware ID chip does not exists, a null signal is sent back to show that ID chip does not exist. Note that except the hardware ID code, all the functions of the V-chip and the phone are available, irrespective of the existence of the hardware ID chip.

Hardware ID code goes one step further in filtering calls and can be set to prevent the phone from ringing on unknown calls. V-chip is installed between the phone and the socket wall. Therefore, any call has to pass through V-Chip before reaching the phone. It has an operating mode in which it checks the caller's ID before passing the call to the phone and if caller's hardware ID code is not defined in its lookup table, it can block the connection and prevent the phone from ringing.

The electronic circuit inside V-Chip defines all the sequences and the logic operations of the V-chip as explained above.

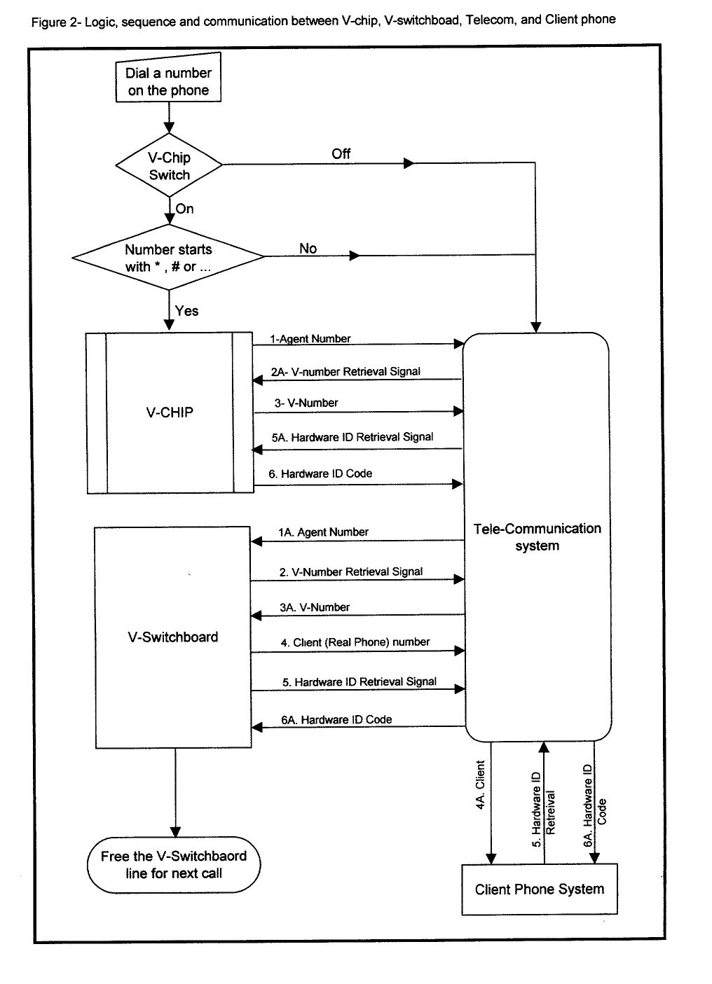

The operation of the V-chip is described in FIG. 2. There is an “On/Off” switch on the phone or on the external V-chip for activation/deactivation of V-chip. V-chip is designed to not interfere with normal phone operation. Therefore, V-chip can be kept activated all the time which is its default and assumed position in below procedure. The sequences of the V-Chip operation are;

1—The user dials a number on the phone keypad.

2—If the dialled number does not start with a special ring signal (*, #), the call is a normal call with real phone number and without any action from V-Chip. However, note that even in normal calls, the hardware ID code can be retrieved by the called party's V-chip through their special frequency signal as described in step 6.

3—If the dialled number starts with a special ring signal (*, #), caller's V-Chip automatically dials the agent's number (V-switchboard phone number) pre-set in the caller's V-chip and keeps the rest of the dialled number in the V-Chip buffer memory.

4—Upon connection, V-switchboard sends the special frequency signal to the caller's V-Chip for retrieving its buffer memory content (i.e.; V-number).

5—The computer connected to the V-switchboard, checks the V-number against its database, finds its corresponding real phone number, and forwards the calls to the associated real phone number. V-switchboard is then released for servicing another call. If the V-number is not defined in the V-switchboard directory, the call is disconnected.

6—Hardware ID code can be retrieved by the called party as an alternate Caller ID. The hardware ID retrieving can be done at any time during the call including before answering the call. For retrieving purposes, the called party's V-chip sends the special frequency signal to the caller's V-Chip to releases its hardware ID code. Hardware ID code then can be checked against Called party's V-Chip lookup table or other means set at called party's side. Called party's V-Chip can be set to prevent the phone from ringing if the caller's hardware ID is not defined in its lookup table which is an efficient way for preventing annoying calls.

As the abbreviated phone numbers are defined and referenced inside the computer connected to the V-switchboard at agent station, they can be used even for a short time. The computer database at the agent station needs to be updated every time a V-number is assigned to a new client (new real phone number). Therefore, all the services are provided and information is updated at a single agent station and there will not be any changes on the user sides (i.e.; V-chips).

### PRIOR ARTS

The abbreviated phone number as a way of speed dialing have been anticipated by Tamura and Darby et al.”. Tamura (CA Patents 2,048,033 and 2,016,859) describing phone memories, which contain full phone numbers and names and can be accessed by abbreviated code and labels. Darby et al. Canadian Application No. 2,335,358, with 13 claims designs a phone with two modes of numbering to allow abbreviated numbering in one of the modes.

This applicant believes that Tamura's and Darby et al. invention do not anticipate applicant's invention in that they are designed for easing calling party's memory access. Those inventions need caller's effort in defining and referencing his abbreviated numbers to the real extended phone numbers and the abbreviated numbers are different from one caller to another one. With today's sophisticated phone memories, which can hold full name and numbers and be sorted numerically or alphabetically, there is not need for abbreviating phone memory.

On the other hand, the applicant's invention is for uniquely defining abbreviated phone numbers to be used by million users among hundreds phone companies and phone area codes and can even be used on the phones without memory. Moreover, the applicant's invention is for adding unique hardware ID code to any phone line and direct phone-to-phone caller ID that is independent of any telephony center and can be retrieved and checked fully automatically, online at any time, and without interruption during a phone connection.

The applicant made extensive search through Canadian, USA, and European (including Japanese) patent offices (see patents U.S. Pat. Nos. 6,125,174, U.S. Pat. No. 616,956, and JP2001169359). All the patents regarding abbreviated phone numbers refer to some sorts of phone memory simplification or abbreviated phone definition in conjunction with only one telephony center similar to some existing phone features (e.g.; *69 for hearing the last number called, and *66 to be notified when a busy line becomes available). Also, the patents regarding call authentication need caller ID (which is not available with many calls) or need some efforts (like password entry or special processor) from the calling party and a telephone-computer combination system with look-up table at the called party side. With all these limitations, the authentication is checked only at the beginning of the call, which does not provide full applicability and privacy and is not useful when the call is forwarded to a new destination, especially in Internet applications.

As mentioned above, the applicant's invention can be used on both existing and new phones with or without memory and the abbreviated phone numbers are defined uniquely among millions of callers and many phone companies and phone area codes. In other words, with applicant's invention, the abbreviated numbers are the same as extended conventional phone numbers that can be declared as contact numbers. Also, as mentioned above, unique hardware ID code, which is retrievable and checkable fully automatically and direct phone-to-phone caller ID are disclosed for the first time by the applicant's.

Therefore, the applicant does not believe that previous disclosures anticipate on the applicant's invention from any standpoint.

1. The abbreviated phone numbers having smaller and variable dialled digits, carrying a non-numeric prefix ring signal from key-phone system (*, #, #*, *#, or new key added to the key phone as prefix), and can be used as a contact phone number in telecommunication systems having extended phone numbers (conventionally 7-10 dialled digits).

2. The call-processing circuit comprising a pre-set phone number of an agent station, a memory for storing dialled digits from a key-phone system to which it is connected, a unique hardware ID code, and On/Off switch.

3. The call-processing circuit as specified in claim 2 also comprising a signal generator, another memory for storing user defined look-up table of the names and hardware ID codes to be used as an alternative caller ID, and a display unit to show the hardware ID code and its corresponding name.

4. The key-phone system (including mobile phone type) having built-in call-processing circuit as specified in claims 2 and 3, wherein stores the dialled digits in the call-processing circuit memory and automatically dials the agent station digits (pre-set phone number of the call-processing circuit) when the call-processing circuit switch is “On” and the first dialled digit from the key-phone system is a prefix ring signal as specified in claim 1.

5. The key-phone system connected to the call-processing circuit as specified in claims 2 and 3 with I/O phone interfaces, wherein stores the dialled digits in the call-processing circuit memory and automatically dials the agent station digits (pre-set phone number of the call-processing circuit) when the call-processing circuit switch is “On” and the first dialled digit on the key-phone system is a prefix ring signal as specified in claim 1.

6. The key-phone system as specified in claims 4 and 5, which releases the stored digits in its call-processing circuit memory (i.e.; abbreviated phone number) into the called party's phone system (herein; telephone-computer integration system at the agent station) upon receiving the specific signal from the called party's phone system.

7. The phone system as specified in claims 4 and 5, which releases the hardware ID code of its call-processing circuit into the called party's phone system upon receiving the specific signal from the called party's phone system.

8. The telephone-computer integration system (used at the agent station) with signal generating circuit for sending the specific signal to the calling party's call-processing circuit for retrieving its memory content (i.e; abbreviated phone number) and for forwarding the abbreviated phone number to its corresponding conventional phone number in coordination with computerized look-up table of the abbreviated and their corresponding conventional phone numbers.

9. The call processing circuit as specified in claim 3 that allows the user to generate/modify a look-up table of the said hardware ID codes and names such that upon receiving a hardware ID code, its corresponding name from the look-up table is displayed to be used as direct phone-to-phone caller ID without involvement of any telephony center.

10. The call processing circuit as specified in claim 3 (at the called party's phone system) for sending the specific signal to the calling party's call-processing circuit and retrieving its hardware ID code and to further display it along with the corresponding name from its own look-up table.

11. The method for direct phone-to-phone caller ID as specified in claims 9 and 10 totally independent of any telephony centre with the benefits of more applicability, efficient annoying call filtration, and higher privacy for both calling and called parties.

12. The prefix ring signals as specified in claim 1 that will not be used in future telecommunication applications in a way that interfere with the said V-chip applications.
